(19) United States
(12) Patent Application Publication
(10) Pub. No.: US 2009/0290160 A1
(43) Pub. Date: Nov. 26, 2009

(54) WAVELENGTH SWEEP CONTROL

(76) Inventor: DOMINO TAVERNER, Wallingford, CT (US)

Correspondence Address: PATTERSON & SHERIDAN, L.L.P., 3040 POST OAK BOULEVARD, SUITE 1500, HOUSTON, TX, 77056, US

(21) Appl. No.: 12/541,770

(22) Filed: Aug. 14, 2009

Related U.S. Application Data
(63) Continuation-in-part of application No. 11/755,131, filed on May 30, 2007.
(60) Provisional application No. 60/803,470, filed on May 30, 2006.

(51) Int. Cl. G01N 21/25; G01M 11/02

(52) U.S. Cl. 356/419

(57) ABSTRACT

Methods and apparatus for the active control of a wavelength-swept light source used to interrogate optical elements having characteristic wavelengths distributed across a wavelength range are provided.

### CROSS-REFERENCE TO RELATED APPLICATIONS

This application is a continuation-in-part of co-pending U.S. patent application Ser. No. 11/755,131 filed May 30, 2007, which claims benefit of U.S. Provisional Patent Application Ser. No. 60/803,470, filed May 30, 2006, which are herein incorporated by reference.

### BACKGROUND OF THE INVENTION

1. Field of the Invention

Embodiments of the present invention generally relate to determination of a characteristic wavelength of an optical component and, more particularly, to techniques and apparatus for controlling the manner in which a spectral bandwidth is swept in an effort to determine the characteristic wavelength.

2. Description of the Related Art

Many optical components have a characteristic wavelength that may be found by interrogating the optical component with an optical source capable of producing light at various wavelengths over a fixed range or bandwidth. For example, Bragg gratings (typically formed by photo-induced periodic modulation of the refractive index of an optical waveguide core) are highly reflective to light having wavelengths within a narrow bandwidth centered at a wavelength generally referred to as the Bragg wavelength. Because light having wavelengths outside this narrow bandwidth is passed without reflection, Bragg wavelengths can be determined by interrogating a Bragg grating with a light source swept across a bandwidth that includes the Bragg wavelength and monitoring the reflected optical power spectrum at a receiver unit. Because Bragg wavelengths are dependent on physical parameters, such as temperature and strain, Bragg gratings can be utilized in optical sensor systems to measure such parameters.

In these and a wide range of other types of optical systems, the measurement of a characteristic wavelength of an optical component to great accuracy (and/or with great repeatability) is important to system performance. Two significant parameters determining the error of any such measurement are the signal to noise ratio (SNR) and effective integration time of the measuring system. SNR is dependent of many factors including received optical power, optical-source noise, and receiver noise. The effective integration time is dependent on overall averaging time and the proportion of that time which is producing useful signals at the receiver unit. Improving these two parameters can improve characteristic wavelength measurement repeatability and accuracy.

In a typical system, with a fixed spectral bandwidth sweep, a large percentage of the interrogation time is spent covering wavelengths where no useful signal is returned by the optical element under test. This may be particularly true in the case where multiple elements (e.g., multiple Bragg gratings disposed serially on a common fiber) are combined in a commonly used wavelength-division multiplexing (WDM) scheme. In these arrangements, wavelength guard-bands are typically required between the spectral features of elements, for example, to ensure the elements have non-overlapping spectral features over the entire expected measurement range and even as some movement in the spectral features may be expected over time. These guard-bands increase the total range of wavelengths scanned, thereby increasing the amount of interrogation time spent covering wavelengths that produce no useful signal.

Accordingly, techniques and systems that optimize the useful received signal, reduce SNR, and reduce the total amount of interrogation time would be desirable.

### SUMMARY OF THE INVENTION

Embodiments of the present invention generally provide methods and apparatus for interrogating sensors elements having characteristic wavelengths spread across a wavelength range.

One embodiment of the present invention is a method. The method generally includes filtering light emitted from an amplified spontaneous emission (ASE) source, amplifying the filtered light, and interrogating one or more optical elements with the amplified light to measure one or more parameters.

Another embodiment of the present invention provides an apparatus for interrogating one or more optical elements. The apparatus generally includes an ASE source for emitting light, a filter for filtering the light emitted by the ASE source, and an amplifier for amplifying the filtered light, such that the amplified light is used to interrogate the optical elements.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates an exemplary transmissive optical sensor system with wavelength sweep control;

FIG. 1B illustrates an exemplary reflective optical sensor system with wavelength sweep control;

FIG. 2 illustrates an exemplary wavelength sweeping optical source utilizing a tunable filter;

FIG. 3 illustrates how sweep rates may be varied for different wavelength regions of interest in accordance with embodiments of the present invention;

FIG. 4 illustrates how optical power may be varied for different wavelength regions of interest in accordance with embodiments of the present invention;

FIG. 5 illustrates how wavelength features of interest may shift over time and how sweep rates of corresponding wavelength regions may be adjusted accordingly;

FIG. 6 is a flow diagram of exemplary operations for varying wavelength sweep parameters based on feedback from previous sweeps;

FIG. 7 is a flow diagram of exemplary operations for varying wavelength sweep parameters of a current sweep based on feedback;

FIG. 8 is a flow diagram of exemplary operations for varying sweep rates based on specified sensor resolutions;

FIG. 9 is a flow diagram of exemplary operations for automatically discovering a sensor topology during a sweep of a range of wavelengths;

FIG. 10 illustrates an exemplary wavelength sweeping optical source utilizing an amplified spontaneous emission (ASE) source, a tunable filter, and an amplifier;

FIG. 11 illustrates an exemplary reflective optical sensor system with the optical source of FIG. 10; and

FIG. 12 illustrates an exemplary reflective optical sensor system with an exemplary ASE source and an exemplary optical amplifier.

### DETAILED DESCRIPTION OF THE PREFERRED EMBODIMENT

Embodiments of the present invention provide for the active control of a light source used to interrogate optical elements having characteristic wavelengths distributed across a wavelength range.

For some embodiments, this active control may include varying sweep rates across different ranges. For example, a sweep rate may be reduced in ranges containing spectral features of interest, allowing more measurements, which may lead to increased resolution. On the other hand, the sweep rate may also be increased in order to skip, or otherwise move rapidly through, other ranges (e.g., ranges absent features of interest or ranges corresponding to measured parameters that do not require as high resolution as others or as frequent measurements). Further, for some embodiments, particular ranges (sweep bands) may be adjusted, for example, to follow features of interest as they shift (e.g., change in wavelength) over time.

Different embodiments of the present invention may utilize wavelength sweep control described herein in systems utilizing transmissive or reflective type sensors. Further, embodiments of the present invention may be applied in a number of different sensing applications, including, but not limited to, industrial applications, downhole applications (e.g., in wellbore sensing applications), and subsea applications (e.g., ocean bottom seismic sensing applications).

### An Exemplary System

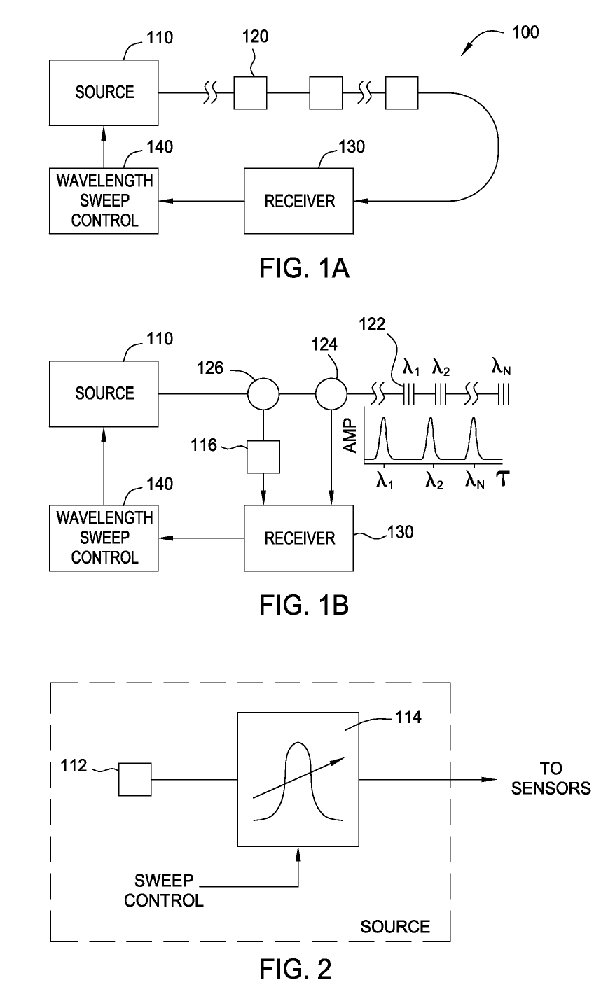

FIG. 1A illustrates an exemplary optical sensor system 100 utilizing wavelength sweep control in accordance with one embodiment of the present invention. As illustrated, the system 100 may include a swept-wavelength optical source 110, one or more transmissive optical elements 120 having one or more spectral features of interest (e.g., a characteristic wavelength), and a sweep control unit 140.

The swept-wavelength optical source 110 produces optical radiation at wavelengths and over wavelength ranges (bandwidths) under the control or influence of the sweep control unit 140. The elements 120 may be interrogated with optical radiation from the optical source 110 that is swept across a spectral range including the spectral features of interest. The elements 120 may be sensitive to parameters (e.g., temperatures, pressures and strain) that effect the attenuation of particular wavelengths of light transmitted through the elements 120 in a known manner.

As illustrated in FIG. 2, one embodiment of the optical source 110 may include a broadband source 112 and a tunable filter 114 that may be controlled by the sweep control unit 140. For example, the sweep control unit 140 may control the tunable filter 114 to adjust a wavelength range (or band) to pass with little or no attenuation while blocking wavelengths outside the range. For other embodiments, the optical source 110 may include a light source that can be controlled to generate optical signals of different wavelengths, such as a tunable laser.

Referring back to FIG. 1A, a receiver 130 may include any suitable combination of optical, opto-electronic, and electronic components to process light signals transmitted through the elements 120. Thus, the receiver 130 may be able to generate information about the corresponding parameters, based on the spectral information extracted from the received light. The receiver 130 may include any suitable combination of components that converts optical signals to electrical signals, integrates, filters and produces characteristic wavelength determinations. As an example, for one embodiment, the receiver may include an optical PIN diode, transimpedance amplifier, analog filter, analog-to-digital converter, digital filter and processing unit (e.g., an embedded processor, industrial or personal computer) for wavelength determination.

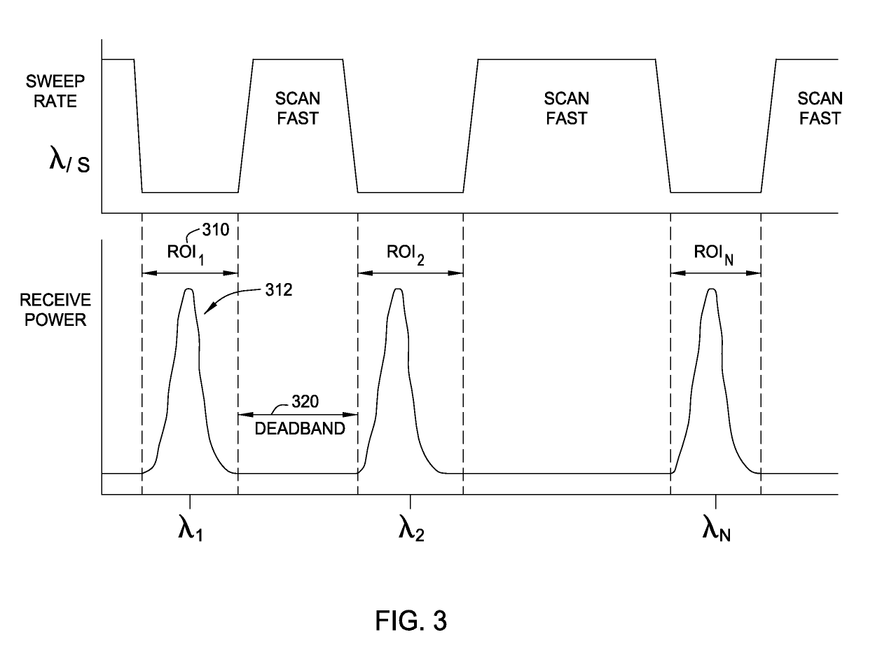

As illustrated, the sweep control unit 140 may receive, as input, one or more signals from one or more points in the receiver 130 and, in response, may output signals that influence the sweep of the optical source 110. Examples of typical parameters that the sweep control unit may influence include, but are not limited to, source wavelength, source wavelength sweep range, sweep rate, and/or source optical output power. These influences may include discontinuous or continuous changes in such parameters, for example, multiple sweep bands (FIG. 3). The sweep control unit signals can influence a sweep as it is in progress and/or influence future sweeps, as will be described in greater detail below.

The sweep control unit 140 may be implemented using any suitable processing logic, such as an embedded controller, a programmable logic controller (PLC) or personal computer (PC). While shown as a separate component in the Figures, for some embodiments, the sweep control unit 140 may be integrated into, or be an integral function of the receiver 130, source 110, and/or both.

As illustrated in FIG. 1B, similar techniques may be applied to a system utilizing reflective sensor elements 122, such as Bragg gratings, with the spectral feature of the light reflected dependent upon a sensed parameter. Each Bragg grating 122 may be interrogated by sweeping across a corresponding wavelength range chosen to contain the characteristic wavelength A, accounting for the maximum deviations in center wavelengths (areas of peak reflection) expected over the entire range of measured parameters and over time. During this interrogation, response signals are monitored by the receiver 130 in order to make characteristic wavelength determinations.

Interrogating optical signals from the source 110 may be directed to the gratings 122 via a bi-direction coupler 124 that also directs reflected response signals to the receiver 130. A splitter 126 may also direct a portion of the interrogating optical signals to a reference element 116, allowing the receiver 130 to monitor optical signals produced by the optical source 110 (e.g., the actual wavelength and power).

As previously described, wavelength division multiplexed (WDM) systems, such as the system 100 typically have deadbands between sensor wavelengths, to ensure non-overlapping characteristic wavelengths. In conventional systems, these deadbands add to the total swept wavelength range, thereby increasing overall interrogation time and decreasing the percentage of this time a useful response signal is produced. However, embodiments of the present invention may increase the percentage of time spent producing useful response signals by skipping these deadbands or at least increasing the sweep rate to rapidly sweep through them.

### Varying Sweep Rates

FIG. 3 illustrates an exemplary spectral response for a system (power of received response signals versus wavelength), with multiple swept ranges 310 containing spectral features of interest 312. As illustrated, regions of interest may be scanned with a first (relatively slow) scan rate, while deadbands 320 may be scanned with a second (relatively faster) scan rate or skipped altogether. For some embodiments, for example, due to limited response time of the source 110 (e.g., due to physical, mechanical, or electrical limitations), it may not be possible to entirely skip a wavelength range and therefore deadbands may be swept with increased sweep rate (relative to the ranges of interest 310).

In either case, controlling the sweep rate in this manner may increase the useful optical energy received from the optical elements in a given interrogation time. As a result, overall interrogation time may be reduced relative to conventional systems or, alternatively, more measurements may be taken in the same interrogation time, allowing an increased “focus” on ranges of interest, which may increase accuracy.

Different sweep rates may also be utilized for different ranges of interest, to interrogate different sensors at different rates, which may provide a great deal of flexibility in overall system design. For example, a first sensor (e.g., having a first characteristic wavelength λ1) may be interrogated using a lower sweep rate than that used to interrogate a second sensor (λ2). As a result, more measurements may be taken for the first sensor, which may be lead to higher accuracy measurements, while the second sensor may be used for more coarse measurements. Using this approach, some sensors may be designated as “high resolution” sensors and interrogated with lower sweep rates (sampled more often) than other sensors.

At a different point in time, it may become desirable to take higher accuracy measurements of the second sensor. Therefore, the sweep rates of different sensors may be changed from one sweep to the next. For example, for some applications, it may only be necessary to take highly accurate measurements of certain parameters in certain situations (e.g., when the parameter is changing rapidly, or has reached a particular threshold value). In some instances, high accuracy measurements (low sweep rate) of a particular parameter may only be made when a coarse measurement of the same parameter (taken in a current or previous sweep) indicates a particular value or range.

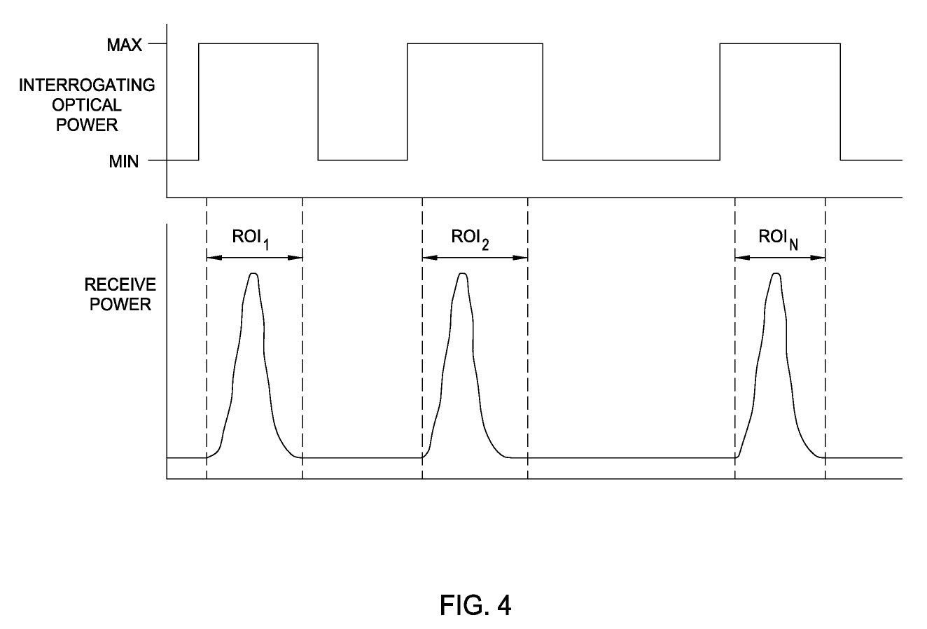

As illustrated in FIG. 4, for some embodiments, the optical power of interrogating light signals may also be varied for different swept ranges (as an alternative to, or in conjunction with, varying sweep rates). For example, optical power may be decreased when sweeping across dead ranges. This approach may allow optical power to be conserved. For some embodiments, reduced optical power may be used to scan particular swept ranges, until a particular threshold level of optical response signal is received.

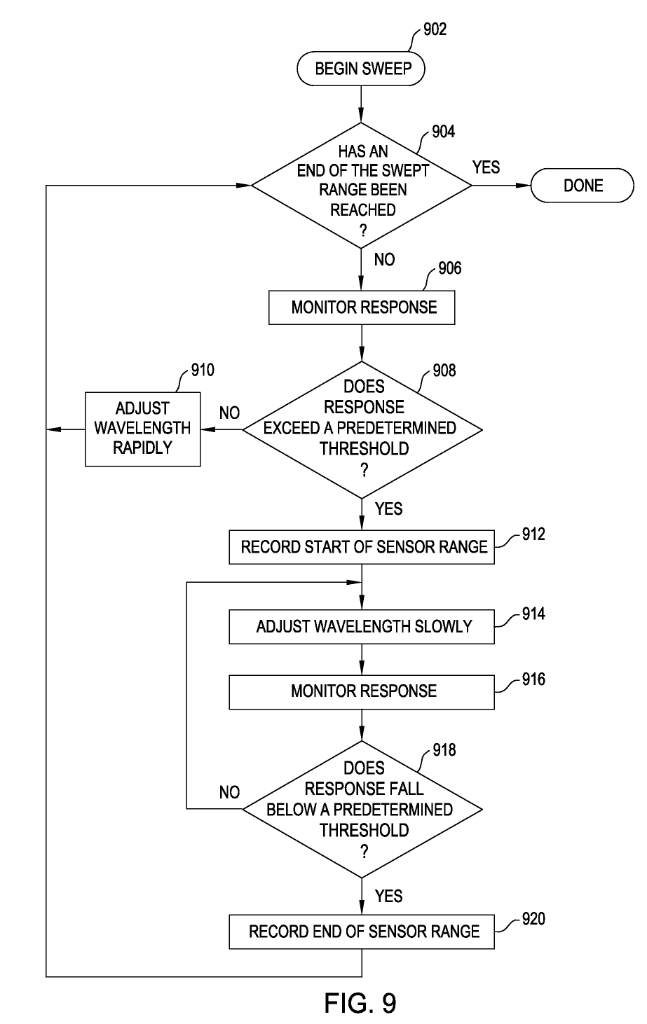

Changes in the received power from the optical element (or optical system) could also be compensated for, by adjusting the source output power for example. As will be described in greater detail below, with reference to FIG. 9, monitoring response signals while quickly sweeping and/or interrogating with lowered optical power over particular swept ranges may be performed as part of a process to automatically “discover” a particular sensor topology.

### Adjusting Ranges of Interest

Embodiments of the present invention may also allow for only a limited band of wavelengths directly surrounding particular spectral features of interest to be swept by the source. The wavelength sweep control unit may continuously adjust the swept bands/ranges to track these features, should they change in wavelength over time.

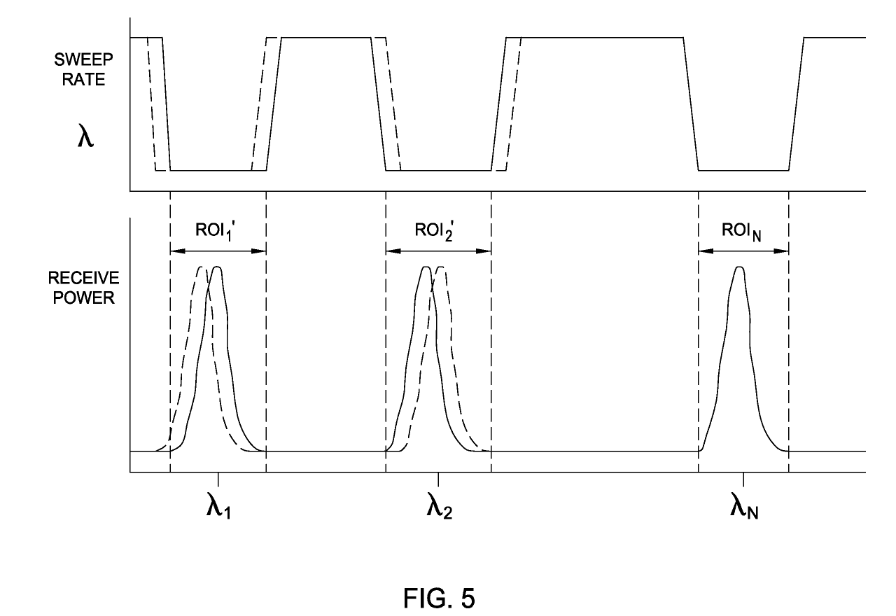

For example, as illustrated in FIG. 5, the characteristic wavelength of a first sensor (λ1) may change over time, such that the region of interest, defined by the expected deviation in wavelength of the sensor, may shift over time. A previous region of interest is shown as a dashed line, while the new region of interest is shown as a solid line. In the illustrated example, a positive shift for λ1 is shown. As illustrated in the upper graph of FIG. 5, in response to this shift, the wavelength sweep control 140 may adjust the corresponding swept range (swept with a relatively low sweep rate and/or a relatively high optical power) for λ1 to compensate for the shift. As illustrated, the characteristic frequency for a second sensor (λ2) may shift in the opposite direction, which may cause the wavelength sweep control 140 to adjust the corresponding swept range accordingly.

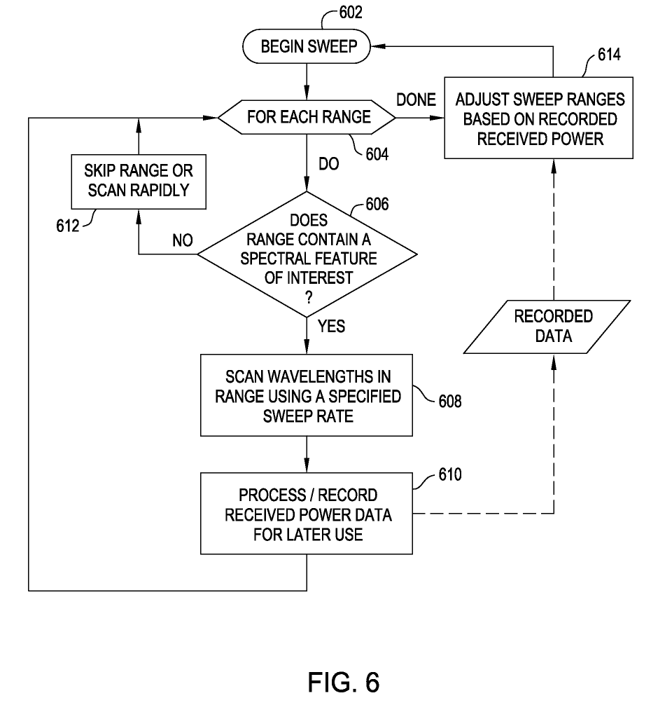

FIG. 6 is a flow diagram of exemplary operations that may be performed, for example, by the wavelength sweep control 140 to vary wavelength sweep parameters based on feedback from previous sweeps. At step 602, a sweep begins, for example by interrogating optical elements with light signals having a wavelength at a low end of a total range to be swept. As described above, the total range to be swept may be divided into ranges (e.g., ranges of interest and deadbands).

At step 604, a loop of operations is entered, to be performed for each range. At step 606, a determination is made as to if a current range contains a spectral feature of interest. If the current range does not contain a spectral feature of interest, the range can be skipped or, at least, scanned rapidly, at step 612. If the current range contains a spectral feature of interest, wavelengths in the range may be swept at a specified (relatively slow) sweep rate, at step 608. At step 610, the received power (response signal) may be recorded for later use.

The operations may be repeated (e.g., slowly sweeping ranges of interest and rapidly sweeping deadbands), until all ranges have been swept. At step 614, the swept ranges may be adjusted based on the recorded received power, for example, as described above with reference to FIG. 5. These adjusted swept ranges may then be used in a subsequent sweep. In this manner, the wavelength sweep control 140 may continuously adjust sweep parameters to compensate for changing sensor characteristics.

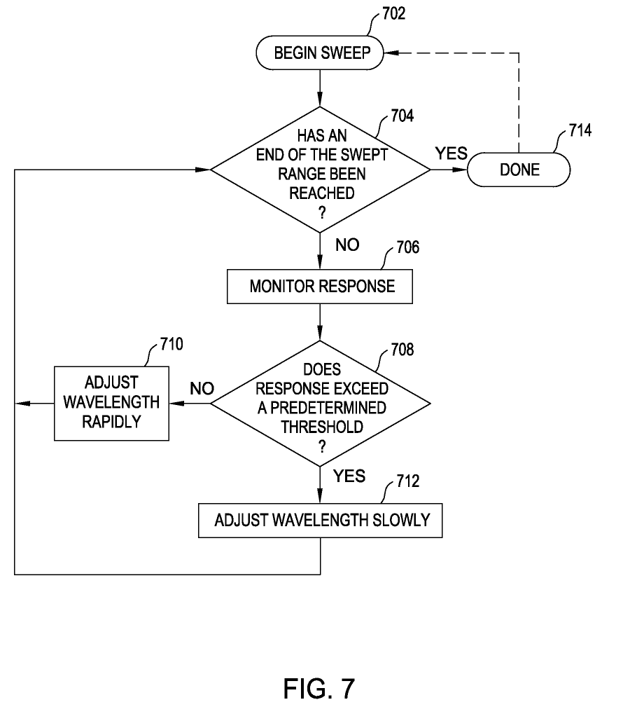

FIG. 7 is a flow diagram of exemplary operations for varying wavelength sweep parameters of a current sweep based on feedback. The operations shown in FIG. 7 may be performed to sweep without using predefined sweep ranges, for example, by sweeping rapidly until some level of response signal is detected indicating a sensor region of interest has been reached. As an alternative, the operations of FIG. 7 may be performed with predefined sweep ranges, for example, in an effort to detect spectral information occurring in what was thought to be a deadband.

At step 702, a sweep begins. At step 706, the optical response is monitored. As long as the response does not exceed a predetermined threshold, as determined at step 708, the wavelength is adjusted rapidly. Once the response does exceed the predetermined threshold, the wavelength is adjusted slowly. These operations may repeat, until the end of a swept range has been reached, as determined at step 704. Thus, these operations may allow regions that contain no spectral feature of interest (as evidenced by a lack of response signal) to be quickly scanned.

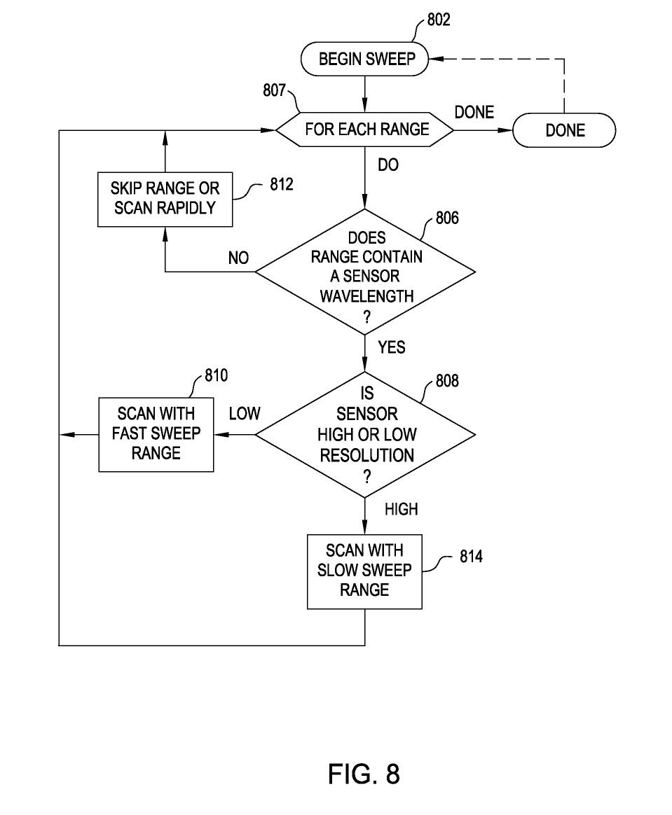

FIG. 8 is a flow diagram of exemplary operations for varying sweep rates based on specified sensor resolutions. As previously described, some sensors may be identified as high resolution sensors that may be scanned slower (allowing more samples to be taken) or that may be scanned with interrogating signals having higher optical power. Other sensors, identified as low-resolution sensors may be scanned more rapidly (although not as quickly as a deadband) or that may be scanned with interrogating signals having relatively lower optical power.

At step 802, a sweep begins and, at step 804, a loop of operations is entered, to be performed for each range. At step 806, a determination is made as to if a current range contains a characteristic wavelength of a corresponding sensor. If the current range does not contain a sensor wavelength, the range can be skipped or, at least, scanned rapidly, at step 812. If the current range contains a sensor wavelength, a determination is made, at step 808, as to whether the corresponding sensor is a high or low-resolution sensor.

If the sensor is a low-resolution sensor, the range may be scanned with a relatively fast sweep range (but slower than that used to sweep a deadband), at step 810. If the sensor is a high-resolution sensor, the range may be scanned with a relatively slow sweep range, at step 814. The operations may be repeated until all ranges have been swept.

FIG. 9 is a flow diagram of exemplary operations for automatically discovering a sensor topology during a sweep of a range of wavelengths. The operations may be performed, for example, as an initial operation to determine the types of sensors that are present in an optical system without requiring field personnel to enter corresponding data manually. In some cases, sensor vendors may sell sensors with known characteristic wavelengths (or wavelength ranges), allowing corresponding data to be pre-stored in the system. In such cases, if the characteristic wavelengths are automatically detected during a sweep, it may be a simple matter of looking up the actual device characteristics, such as the response changes in wavelength as a function of a corresponding measurand (e.g., pressure, temperature, strain, and the like).

At step 902, a sweep of a wavelength range begins. At step 904, a determination is made as to if the end of the range has been reached. If not, the optical response is monitored (or continues to be monitored), at step 906. At step 908, if the monitored response does not exceed a predetermined threshold (e.g., indicating the absence of a characteristic wavelength at or near the current swept wavelength), the wavelength may be adjusted rapidly, at step 910.

On the other hand, if the monitored threshold exceeds a predetermined threshold (e.g., indicating a characteristic wavelength at or near the current swept wavelength), the start of a sensor range may be recorded, at step 912. Because the current wavelength may be at or near a characteristic sensor wavelength, the wavelength may be adjusted slowly, at step 914, while continuing to monitor the optical response, at step 916. The sensor range may include all wavelengths for which the monitored response remains above the predetermined threshold. If the monitored response falls below the predetermined threshold (in some cases allowing for some amount of hysteresis), as determined at step 918, the end of the sensor range may be recorded, at step 920. The operations may be repeated until the entire range has been swept.

Those skilled in the art will also recognize that different aspects described herein may be combined, for some embodiments. As an example, for some embodiments, wavelength sweep control logic may be configured to perform different combinations of operations shown in the flow diagrams described above, to provide different combinations of features.

### Amplifier Configuration for a Bragg Grafting Interrogator

For some embodiments, an amplified spontaneous emission (ASE) source may be utilized as the optical source 110 for interrogating the optical elements. Spontaneous emission can occur in an optical fiber when electrons in an upper energy level decay to a lower energy level, spontaneously emitting photons in all directions. Some of these photons are emitted in a direction falling within the numerical aperture of the fiber such that these particular photons are captured and guided by the fiber. In a doped optical fiber, the captured photons from the initial spontaneous emission may then interact with dopant ions and consequently be amplified by stimulated emission, hence the term “amplified spontaneous emission.” Accordingly, ASE may be considered as light, produced by spontaneous emission, that has been optically amplified by the process of stimulated emission in a gain medium.

However, the spectral power density of typical ASE sources is low compared to ordinary laser output power densities. In swept-wavelength grating interrogation systems, such low ASE source output spectral power density can strain the optical power budget, thereby limiting the maximum sensor reach.

Historically, this problem has been addressed by a number of approaches having varying success and a number of disadvantages. One approach has been to work within the constraints of the resulting optical power budget by employing highly sensitive receivers. However, such receivers can be expensive, and the improvements are limited. Another approach has been to simply try to increase the output power of the ASE source.

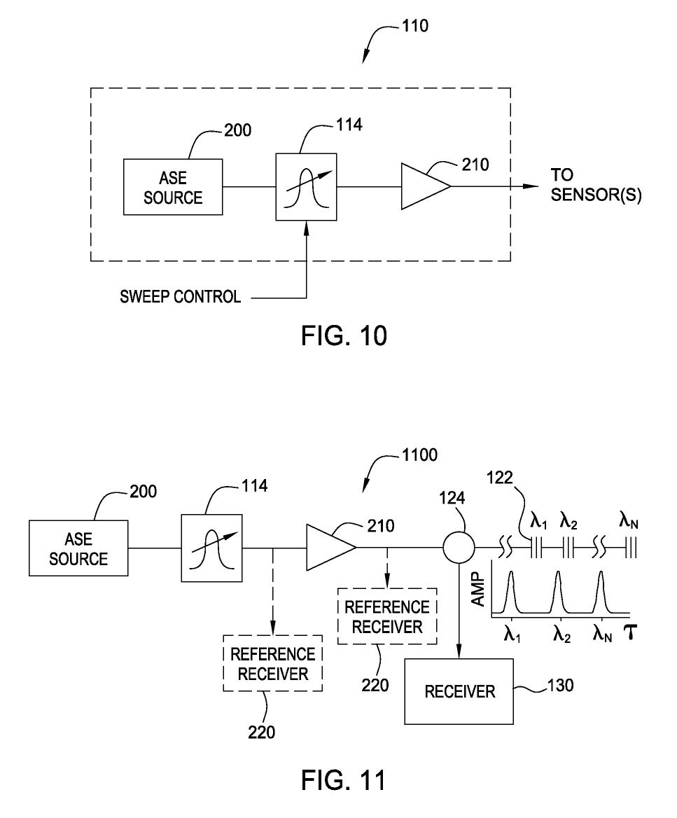

To overcome these problems, FIG. 10 illustrates an exemplary wavelength sweeping optical source utilizing an ASE source 200, a tunable filter 114, and an amplifier 210. As described above, ASE is produced when a gain medium is stimulated (e.g., pumped) to produce a population inversion. The ASE source 200 may comprise an optical fiber doped with dopant ions and having a length of several meters as the laser gain medium. For example, the core of a silica fiber may be doped with trivalent erbium ions (Er⁺³) to fabricate an erbium-doped fiber. Pumping may be achieved with electrical currents (e.g., produced by semiconductors, or by gases via high-voltage discharges) or with light, generated by discharge lamps or by other lasers (e.g., semiconductor lasers). A laser used to pump a doped fiber is known as a pump laser.

The tunable filter 114 may function as described above to produce a narrow band (i.e., range) of wavelengths from the broadband ASE source 200. The narrow wavelength band passing through with little or no attenuation may be adjusted as the filter 114 is tuned. For some embodiments, the tunable filter 114 may be controlled by the sweep control unit 140 as described above.

The amplifier 210 may boost the narrow band swept-wavelength signal from the tunable filter 114 and output the amplified signal for interrogation of the optical elements, such as the transmissive optical elements 120 or the reflective sensor elements 122 described above. For example, the amplifier 210 may provide a gain of 30 dB, such that 20 to 50 μW may be amplified to 20 to 50 mW. Using the amplifier 210 after the tunable filter 114 may provide for a substantial increase in the output signal level of the optical source, independent of the constraint to prevent lasing in the ASE source 200.

The amplifier 210 may comprise an optical amplifier, which amplifies a light signal directly. For some embodiments, the optical amplifier may comprise a doped fiber amplifier (DFA). A DFA is an optical amplifier that uses a doped optical fiber as a gain medium to amplify an optical signal. In a typical DFA, the optical signal to be amplified and light from a pump laser (pump light) are multiplexed into the doped fiber, and the signal is amplified through interaction with the dopant ions. More specifically, the pump light excites the dopant ions to higher energy levels (orbits), and the input optical signal stimulates the excited dopant ions to release excess energy as photons in phase and at the same wavelength as the input signal. The doped fiber may comprise erbium ions to produce an erbium-doped fiber (EDF), although dopant ions of thulium, praseodymium, or ytterbium have also been implemented.

For other embodiments, the optical amplifier may comprise a semiconductor optical amplifier (SOA). An SOA is typically made from group III-V compound semiconductors, such as GaAs/AlGaAs, InP/InGaAs, InP/InGaAsP, and InP/InAlGaAs. Although an SOA is generally less expensive than a DFA and can be integrated with semiconductor lasers, current SOAs have higher noise, lower gain, moderate polarization dependence, and high nonlinearity with fast transient time. However, an SOA may provide for gain in different wavelength regions than a DFA.

By amplifying the narrow band swept-wavelength emission from the ASE source 200 as illustrated in FIG. 10, the limitations on the optical power budget may be resolved, and the ASE source 200 may be suitable for use in a swept-wavelength optical sensor system.

FIG. 11 illustrates an exemplary reflective optical sensor system 1100 employing the optical source 110 of FIG. 10. This system 1100 is similar to the reflective optical sensor system 100 of FIG. 1B and includes the bidirectional coupler 124, the reflective sensor elements 122, and the receiver 130. Interrogating optical signals produced by tuning and amplifying light emitted from the ASE source 200 may be directed to the reflective sensor elements 122 (e.g., fiber Bragg gratings, or FBGs) via the bidirectional coupler 124. The coupler 124 may also direct response signals reflected from the reflective sensor elements 122 to the receiver 130 for optical detection and signal processing. For some embodiments, the coupler 124 may be replaced with an optical circulator.

Some embodiments may include an optional reference receiver 220 in an effort to monitor optical signals produced by or internal to the optical source 110. The reference receiver 220 may monitor optical signals before and/or after the amplifier 210 as shown. The reference receiver 220 may incorporate a reference element 116 as described above. The optical signals may be directed to the reference receiver 220 via a splitter (not shown), similar to the splitter 126 of FIG. 1B. The reference receiver 220 may be independent from the receiver 130 or may be incorporated (at least partially) into the receiver 130.

For some embodiments, the reflective sensor elements 122 may comprise cane-based gratings, where the gratings are inscribed in a large diameter waveguide (referred to as a “cane waveguide”) rather than in an optical fiber. Cane waveguides have a core and a cladding just as do standard fibers. In fact, the core of a single mode cane is generally the same diameter as the core of a single mode standard fiber, typically 7 to 12 μm (microns). However, cane is thicker and sturdier than fiber because of the substantial amount of cladding. While a standard fiber has a diameter of 125 μm, cane typically ranges from 0.3 mm to about 4 mm, the great bulk of which constitutes cladding. The cane's relatively thick cladding provides significant mechanical benefits over fiber. Furthermore, a cane does not require a protective buffer layer and, thus, eliminates manufacturing complexity.

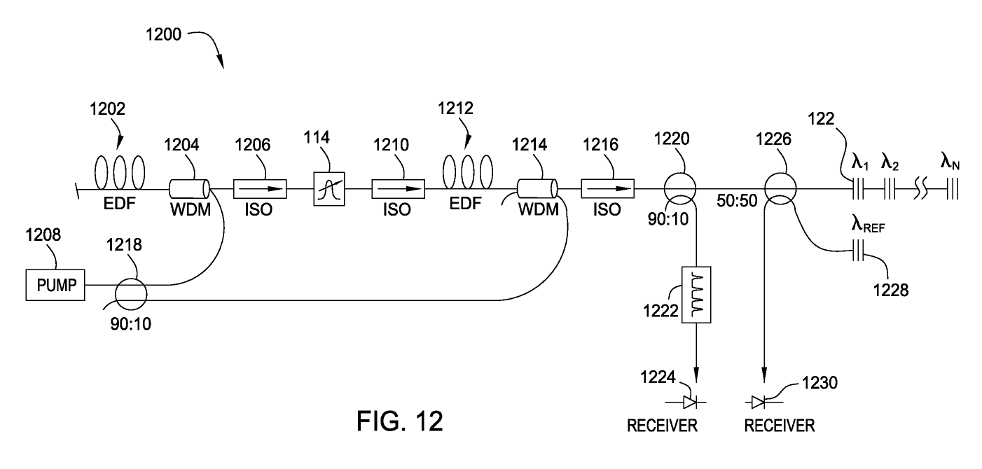

FIG. 12 illustrates an exemplary reflective optical sensor system 1200 with an exemplary ASE source and an exemplary optical amplifier. The ASE source may comprise an erbium-doped fiber (EDF) 1202, a wavelength-division multiplexer (WDM) 1204 with an optical isolator 1206, and a pump laser 1208 as shown. Decay of electrons in the upper energy level may cause spontaneous emission of photons within the EDF 1202. Pump light from the pump laser 1208 may be multiplexed into the EDF 1202 via the WDM 1204 to excite erbium ions to higher energy levels (orbits) in the EDF. The spontaneously emitted photons may stimulate the excited erbium ions to release excess energy as photons, such that the EDF 1202, the WDM 1204, and the pump laser 1208 function as an ASE source.

The ASE source may be coupled to the tunable filter 114 via the optical isolator 1206, which directs the light emitted by the ASE source to the filter and blocks light reflected from the filter. The tunable filter 114, in turn, may be coupled to the optical amplifier via another optical isolator 1210. This optical isolator 1210 may direct filtered light to the optical amplifier and block backwards scattered ASE light from the optical amplifier.

The optical amplifier may comprise an erbium-doped fiber (EDF) 1212, a wavelength-division multiplexer (WDM) 1214 with an optical isolator 1216, and a pump laser. As depicted in FIG. 12, the ASE source and the optical amplifier may share the same pump laser 1208, and a splitter 1218 may be used to direct a portion of the pump light to the ASE source and the remaining portion to the optical amplifier. For some embodiments, the splitter 1218 may be a 90:10 splitter or an 80:20 splitter. For example, the 90:10 splitter may direct 90% of the pump light to the ASE source and 10% to the optical amplifier. Since the optical signal input to the amplifier is low (e.g., 20 to 50 μW), only a small amount of power may be required to pump the amplifier, substantially less power than is used for ASE. Consequently, the same pump laser 1208 may be used for pumping both the ASE source and the optical amplifier.

In the amplifier of FIG. 12, the narrow wavelength range optical signal from the tunable filter 114 and pump light from the pump laser 1208 may be multiplexed into the EDF 1212 via the WDM 1214 to excite erbium ions to higher energy levels (orbits) in the EDF. The input optical signal may stimulate the excited erbium ions to release excess energy as photons, such that the EDF 1212, the WDM 1214, and the pump laser 1208 function as an erbium-doped fiber amplifier (EDFA). The WDM 1214 may be coupled to the isolator 1216, such that the amplified optical signal may be directed to the optical sensor elements, but the pump light is blocked.

The optical sensor system 1200 may include a splitter 1220 (e.g., a 90:10 splitter) for directing a portion of the amplified optical signal to a comb filter 1222 and a reference receiver 1224. The comb filter 1222 may produce a reference spectrum having spectrum peaks with a constant, known frequency separation for use as an “optical ruler” during signal processing of the response signals reflected from the sensor elements 122.

A remaining portion of the amplified optical signal may be directed to an optical coupler 1226. The optical coupler 1226 may direct a portion (e.g., half) the amplified optical signal to the reflective sensor elements 122, and a remaining portion (e.g., the other half) to a reference Bragg grating 1228. Light reflected by the reflective sensor elements or the Bragg grating 1228 may be passed back through the optical coupler 1226 and directed to the sensor receiver 1230 for conversion to electrical signals (via a photodiode, for example) and further signal processing. In this manner, accurate sensor measurements may be performed for measuring parameters such as temperature, pressure, and/or strain.

While the foregoing is directed to embodiments of the present invention, other and further embodiments of the invention may be devised without departing from the basic scope thereof, and the scope thereof is determined by the claims that follow.

1. A method comprising:
filtering light emitted from an amplified spontaneous emission (ASE) source;
amplifying the filtered light; and
interrogating one or more optical elements with the amplified light to measure one or more parameters.

2. The method of claim 1, wherein filtering the light comprises tuning an optical bandpass filter to output light having a narrow wavelength range.

3. The method of claim 2, wherein tuning the optical bandpass filter comprises sweeping the filter across a wavelength range for the optical elements.

4. The method of claim 1, wherein amplifying the filtered light comprises multiplexing the filtered light and an output of a pump into a doped optical fiber.

5. The method of clam of claim 4, wherein the pump comprises a pump laser.

6. The method of claim 4, wherein the doped optical fiber comprises an erbium-doped fiber (EDF).

7. The method of claim 1, wherein the optical elements comprise transmissive optical sensors.

8. The method of claim 1, wherein the optical elements comprise fiber Bragg gratings (FBGs).

9. An apparatus for interrogating one or more optical elements, comprising:
an amplified spontaneous emission (ASE) source for emitting light;
a filter for filtering the light emitted by the ASE source; and
an amplifier for amplifying the filtered light, such that the amplified light is used to interrogate the optical elements.

10. The apparatus of claim 9, wherein the ASE source comprises:
an optical fiber doped with dopant ions;
a pump laser for stimulating emission of photons from the dopant ions in the doped fiber to produce the light emitted by the ASE source; and
a wavelength division multiplexer (WDM) for multiplexing pump light emitted from the pump laser into the doped fiber.

11. The apparatus of claim 10, wherein the doped fiber comprises an erbium-doped fiber (EDF).

12. The apparatus of claim 10, wherein the ASE source comprises an optical isolator for directing the light emitted by the ASE source to the filter and for blocking the pump light from the filter.

13. The apparatus of claim 9, wherein the filter comprises a tunable filter for outputting light having an adjustable narrow wavelength range.

14. The apparatus of claim 9, wherein the amplifier comprises an optical amplifier.

15. The apparatus of claim 14, wherein the optical amplifier comprises a doped fiber amplifier (DFA).

16. The apparatus of claim 15, wherein the DFA comprises:
an optical fiber doped with dopant ions, the doped fiber configured to receive the filtered light;
a pump laser for stimulating emission of photons from the dopant ions in the doped fiber; and
a wavelength division multiplexer (WDM) for multiplexing the filtered light and pump light emitted from the pump laser into the doped fiber.

17. The apparatus of claim 16, wherein the doped fiber comprises an erbium-doped fiber (EDF), such that the DFA is an erbium-doped fiber amplifier (EDFA).

18. The apparatus of claim 16, wherein the amplifier comprises an optical isolator for directing the filtered light to the doped fiber and for blocking the pump light from the filter.

19. The apparatus of claim 16, wherein the pump laser is the same pump laser used for both the ASE source and the amplifier.

20. The apparatus of claim 9, wherein the optical elements comprise fiber Bragg gratings (FBGs).
